(19) United States
(12) Patent Application Publication
(10) Pub. No.: US 2008/0244319 A1
(43) Pub. Date: Oct. 2, 2008

(54) Method and Apparatus For Detecting Performance, Availability and Content Deviations in Enterprise Software Applications

(76) Inventors: Smadar Nehab, Tel Aviv (IL); Gadi Entin, Ra'anana (IL); David Barzilai, Sunnyvale, CA (US); Yoav Cohen, Tel Aviv (IL); Ron Wolf, San Bruno, CA (US); Yoav Chernabroda, Yaacov (IL); Roni Floman, Arboleda Drive (IL)

Correspondence Address: GLENN PATENT GROUP, 3475 EDISON WAY, SUITE L, MENLO PARK, CA, 94025, US

(21) Appl. No.: 10/599,541

(22) PCT Filed: Mar. 29, 2005
(86) PCT No.: PCT/US05/10547

§ 371 Date: Apr. 25, 2008

Related U.S. Application Data
(60) Provisional application No. 60/556,902, filed on Mar. 29, 2004.

(51) Int. Cl. G06F 11/28

(52) U.S. Cl. 714/38; 714/E11.178

(57) ABSTRACT

A system (200) comprises a plurality of data collectors (210), a correlator (220), a context analyser (230), a baseline analyser (250), a database (260), and a graphical user interface (GUI) (270). The data collectors (210) are deployed on the services or applications that they monitor, or on the network between these applications as a network appliance, and are designed to capture messages that are passed between the various services. The data collectors (210) are non-intrusive, i.e. they do not to impact the behavior of the monitored services. The data collectors (210) can capture messages transmitted using communication protocols including, but not limited to, SOAP, XML, HTTP, JMS, MSMQ, and the like.

### BACKGROUND OF THE INVENTION

1. Technical Field

The invention relates generally to a method and apparatus for automated performance monitoring. More particularly, the invention relates to a method and apparatus for monitoring of the performance, availability, and message content characteristics of cross application transactions in loosely-coupled enterprise software applications.

2. Discussion of the Prior Art

Enterprises demand high-availability and performance from their computer-based application systems. Automated continuous monitoring of these systems is necessary to ensure continuous availability and satisfactory performance. Many monitoring tools exist to measure resource-usage of these applications or to drive synthetic transactions into enterprise applications to measure their external performance and availability characteristics. Such monitoring tools function to alert an enterprise to failed or poorly performing applications.

There is an increase of use of computer-based application systems that are implemented using loosely-coupled architectures or service oriented architectures (SOA) by the information technology (IT) industry. These applications are referred to herein as “enterprise software applications (ESAs).” An ESA consists of services that are connected through standards-based messaging interfaces. These services are then tied into a transaction that consists of the underlying services that interface each other using function calls and messages.

FIG. 1 is a block schematic diagram of an ESA 100 that is constructed using a loosely-coupled architecture. The ESA 100 comprises several independent services 110-1 through 110-5, each service operating on a different platform. All services are connected to an enterprise message bus 120, which enables each of the services to post a request to any other service or to serve a request submitted by any other service. This is performed by exposing an application programming interface (API) to the other services. The services communicate with each other using communication protocols that include, for example, simple object access protocol (SOAP), hypertext transfer protocol (HTTP), extensible markup language (XML), Microsoft message queuing (MSMQ), Java message service (JMS), and the like. An example of an enterprise application is a car rental system that may include a website that allows a customer to make vehicle reservations through the Internet, a partner system, such as airlines, hotels, and travel agents, and legacy systems, such as accounting and inventory applications.

The transactions of an ESA are invisible to resource-oriented and synthetic transaction based monitoring solutions found in the related art. These monitoring solutions act within a selected silo such as a server, a network, a database, or a web-user experience. In many cases, these silo-monitoring tools indicate that a monitored silo is functioning correctly. However, the transaction as a whole may not be functioning or may be functioning poorly. Often, the full transaction is generically functioning but not functioning in a specific context, and is thus invisible to tools that look at a service or a message out of the application context. Moreover, even if these silos based tools detect a problem, their silo focus illuminates only symptoms within the silo, and therefore the root cause of a transaction problem or deficient performance cannot be determined or highlighted.

It would be, therefore, advantageous to provide a solution that automatically monitors the performance and availability of transactions in ESAs. It would be further advantageous if the provided solution automatically determines the root cause of a transaction problem.

### BRIEF DESCRIPTION OF THE DRAWINGS

FIG. 1 is a block schematic diagram of a typical loosely-coupled enterprise software application (prior art);

FIG. 2 is a block schematic diagram of an automated monitoring system in accordance with the invention;

FIG. 3 is a block schematic diagram showing data collectors attached to enterprise software application in accordance with the invention;

FIG. 4 is a block schematic diagram of an a management server constructed and operative in accordance with the invention;

FIG. 5 is a flowchart showing the operation of the automated monitoring system in accordance with the invention;

FIG. 6 is an example of a matrix view according to the invention; and

FIGS. 7a and 7b provide examples of a deviation graph view according to the invention.

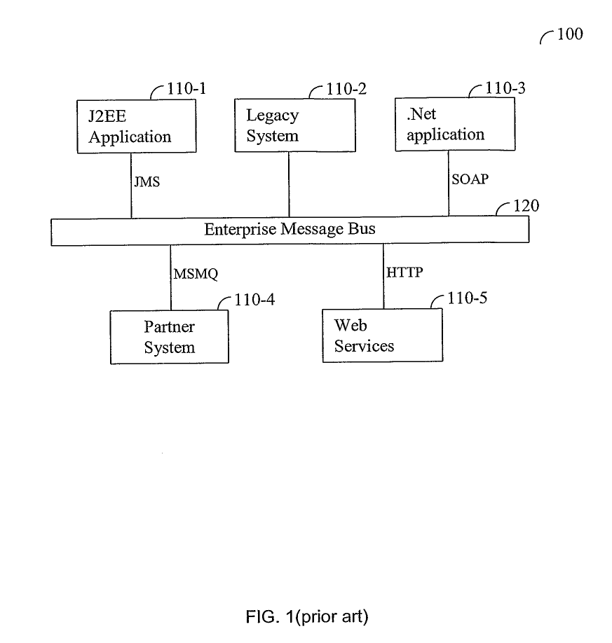

### DETAILED DESCRIPTION OF THE INVENTION

The present invention relates to a method and apparatus for the automated monitoring of the performance, availability, and message content characteristics of cross application transactions in a loosely-coupled enterprise software system. The preferred embodiment intercepts inter-service messages. The invention then analyzes those messages and their derived cross application transactions to show deviations from historic behavior for the specific purposes of detecting performance, availability, and message content related problems. The invention diagnoses the root cause of these problems, and is used in planning and putting processes in place to avoid or mitigate these problems in the future.

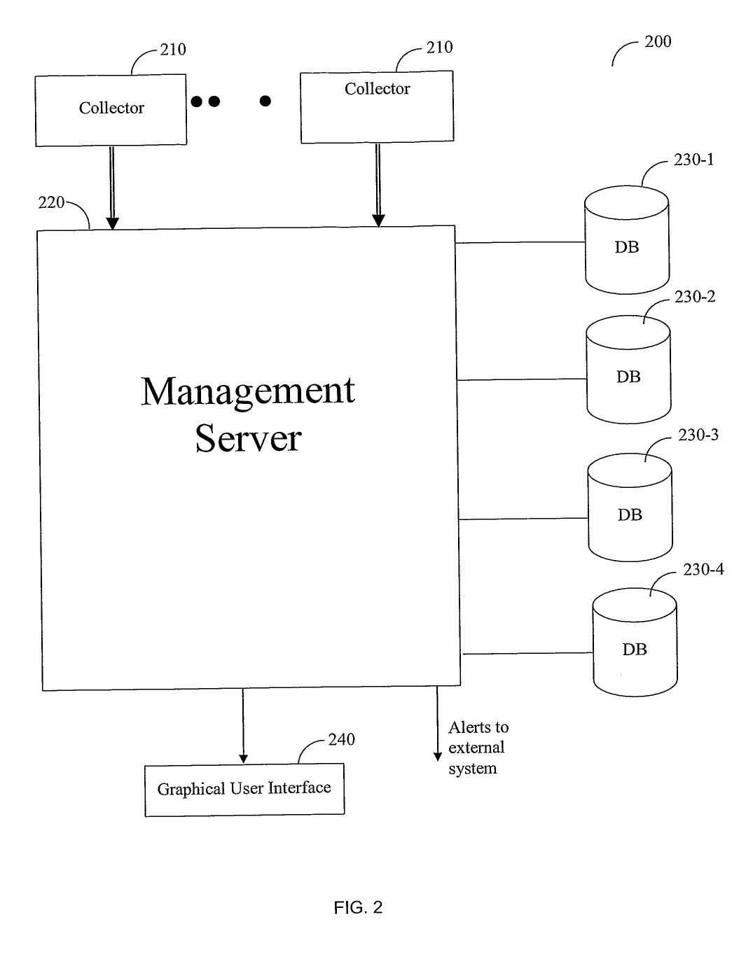

FIG. 2 is a block schematic diagram of an automated monitoring system 200 in accordance with an embodiment of the invention. The system 200 comprises a plurality of data collectors 210 that are connected to a management server 220, databases 230, and a graphical user interface (GUI) 240.

The data collectors 210 are deployed to the enterprise services infrastructure that they monitor, and capture messages that are passed between the various services. Specifically, the data collectors 210 may be either attached to a service or to a message bus. The collectors 210 are either implemented in the process of the monitored service, or in captured messages that are exchanged between the services over message the bus 120.

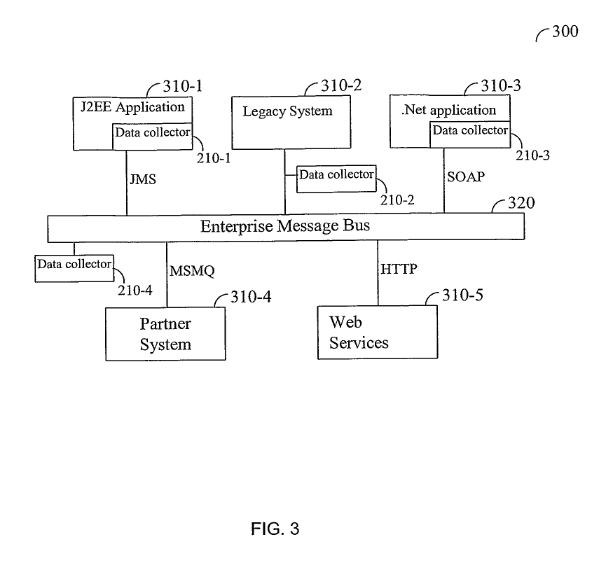

FIG. 3 is a block schematic diagram that shows an exemplary architecture of an ESA which includes data collectors 210 that are implemented in accordance with the invention. As shown, data collectors 210-1, 210-2, and 210-3 are respectively attached to various services 310-1, 310-2, and 310-3. The data collector 210-4 is linked to a message bus 320. The data collectors 210 are non-intrusive, i.e. they do not impact the behavior of the monitored services in any way. Then the collectors 210 can capture messages transmitted using communication protocols including, but not limited to, SOAP, XML, HTTP, JMS, MSMQ, and the like.

The communication protocol to transport data between the data collectors 210 and the management server 220 may include, but is not limited to, SOAP over HTTP, JMS, and the like. The management server 220 provides a central repository for the collection of the service call data and messages collected by the data collectors 210. The management server 220 analyzes the service calls according to a set of rules and further correlates the independent service calls into a transaction, or a transaction instance, of which the service calls are part. The transaction is analyzed according to a set of business rules.

Following are examples for business rules:

a) a business rule ensuring that a service of an airline partner, e.g. a service 110-4, of type X does not perform transaction Y or specific transaction branch Y₁;
b) a business rule that determines that a transaction Y does not generate an alert if that time that transaction Y waits for a response from a partner service X is above a norm; and
c) a rule that determines that a partner X should not be executed on server Z.

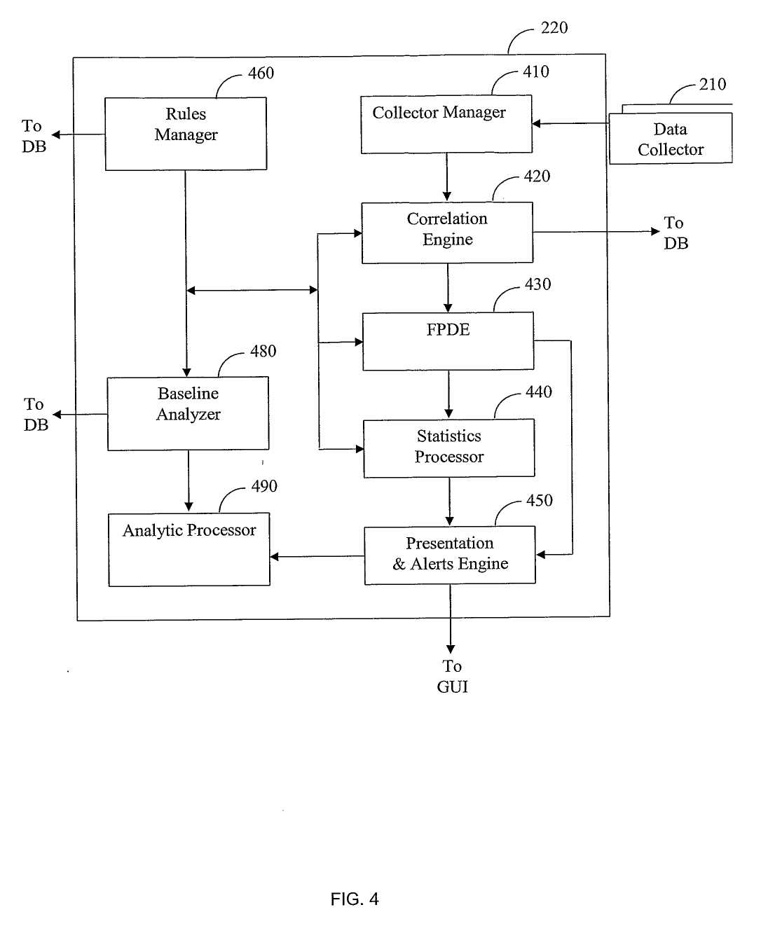

A block schematic diagram of the management server 220 is provided in FIG. 4. The result of transactions analysis is a detailed service flow graph, or a transaction branch, that models the different paths that a transaction may take in different scenarios. From this graph significant information is provided, including the attributes and dependencies that govern the transaction. Additionally, the root cause of failures can be deducted based on this information

The databases (DBs) 230 include at least those for post processing DB 230-1, rules DB 230-2, correlation DB 230-3, and data store DB 230-4. DBs 230 may be implemented in a single repository location, a single DB, or in separate locations. The post processing DB 230-1 maintains data and statistics attributes that are required for determining the behavior of the monitored application. The rules DB 230-2 is repository for standard based specification rules, and implementation based methodologies, constrains and patterns that are used by the various components of the system to define semantics and normal, expected behavior of the monitored system. The data store DB 230-4 maintains the collected service call data. Because it involves masses of data, it is designed to be hierarchal in its nature, keeping recent data in the most detailed way, and reducing the resolution of the data as time passes. The correlation DB 230-3 holds series of correlated service calls.

The GUI 240 displays the user a constant status of the monitored entities, alerts, analytical reports for specified periods of time, and the dependencies between monitored entities. This enables the user to locate the cause of failures in the monitored enterprise application easily. The GUI 240 also enables the user to view the state and statistics variables that were calculated over time. The repots and displays provided by the GUI 240 are discussed in greater detail below.

FIG. 4 is a block schematic diagram of the management server 220 constructed and operative in accordance with the invention. The management server 220 is constructed of several components, each of which is independent and self contained. In one embodiment, communication between the components is performed using the Microsoft messaging infrastructure (MSMQ). The components exchange messages and events using a proprietary persistent publish and subscribe event protocol. This allows flexible packaging of the server at deployment time, and makes it possible to adopt the system to a wide scale of processing power demands. For instance, some components may be combined together and run on a single server. Other components may be separated and deployed on different servers. Each component is also designed to be scalable. That is, several instances of the same component can run on different servers and balance the load between them.

The management server 220 includes a collector manager 410, a correlation engine (CE) 420, a fault prediction and detection engine (FPDE) 430, a statistical processor 440, a presentation and alerts engine 450, a rules manager 460, a baseline analyzer 480, and an analytic processor 490.

The collector manager 410 is responsible for the two-way communication between the collectors 210 and the management server 220. The collector manager 410 receives service call data from the collectors 210 and arranges the service calls into pre-correlated data. The pre-correlated data are saved in a data store DB 230-4. The collector manager 410 also provides an interface for other components in the management server 220 to send commands to a collector 210.

The CE 420 accepts the stream of dispersed service calls as an input, and correlates them to the business transaction. Specifically, the CE 420 executes all activities related to:

a) assembling calls that are related to an instance of a business transaction;
b) determining the execution flow graph of the transaction instance;
c) mapping the execution flow graph of a transaction instance with similar instances; and
d) grouping these instances together to create an execution path that identifies the business transaction i.e. a transaction branch.

To facilitate this, the CE 420 comprises a transaction builder, a learning system, and methodology adapter (not shown in FIG. 4). The CE 420 includes two modes of operation:

a) learning; and
b) maturity (production).

The transaction builder implements pair-wise algorithms and constantly creates chains of coupled service calls based on pre-defined or automatically learned rules. At the learning mode, all incoming data arrives to the learning system, which observes global patterns and rules. Once these rules are identified, they are used by the transaction builder. In the maturity mode, the learning system is fed only with data that could not be correlated by the transaction builder. The CE 420 implements a smart caching algorithm that efficiently uses the RAM of the system 200 without sacrificing solution scalability. It should be appreciated by a person skilled in the art that the CE 420 is capable of handling vast amounts of incoming data to make sure that the system 200 can identify the transaction instances in real-time and can scale well to handle the high loads characterized in the a typical enterprise data center.

The statistics processor 440 collects real-time data and statistics about the attributes of entities and activities within the monitored system. The statistics data are required to analyze and identify proper and improper operation of the various monitored parts within the monitored system. Because the statistics processor deals in real-time with vast amounts of data it must process the incoming data and store the aggregated statistics in a highly efficient manner. The data are stored in a post processing DB 230-1 where they are available for presentation and reporting. The statistics processor 440 aggregates at least the following statistical measures and attributes:

average response time of calls between two services;
throughput of calls to a service;
average response time of transaction instances; and
average response time of transaction and transaction branches.

The data are accumulated over time where a special process maintains differential resolutions of the aggregated data over time. Statistical measures and attributes are assembled in a proprietary data model described in U.S. patent application Ser. No. ______ (unknown) entitled Method and Apparatus for Gathering Statistical Measures, assigned to a common assignee, which patent applications hereby incorporated for all that it contains.

The baseline analyzer 480 maintains a set of saved checkpoints that expresses normal system behavior, and it compares the current activities and statistics to these saved checkpoints. Specifically, the baseline analyzer 480 automates and supplements the process of definition of thresholds on monitored attributes. This is done by using historic statistics of performance, availability and content characteristics to determine expected performance in the future. The baseline analyzer 480 constantly monitors the statistical attributes maintained in the post processing DB 230-1. By applying statistical analysis algorithms, the baseline analyzer 480 computes what are considered to be normal thresholds for the monitored attributes and stores them in a baseline matrix within post processing DB 230-1. The operation of the baseline analyzer 480 is described in greater detail in U.S. patent application Ser. No. ______ (unknown) entitled Method and Apparatus for Detecting Abnormal Behavior of Enterprise Software Applications, assigned to a common assignee, and which is hereby incorporated for all that it contains.

The FPDE 430 operates in conjunction with the baseline analyzer 480. The FPDE 430 detects failures in the operation of the monitored system at the time they occur, or even before they become critical and affect the proper execution of the business transaction. The FPDE 430 employs a sophisticated rule engine that determines the pre-conditions for the identification of a fault. Specifically, the FPDE 430 applies a set of thresholds rules, provided by the baseline analyzer 480, to detect abnormal behavior of the monitored system.

By applying threshold rules, a scoring for the monitored entity is calculated. The scoring is based on the statistical distance of the monitored entity from the expected normal value. The result of the scoring may be one of: normal, degrading, or failure. A threshold rule is a function that is based on the baseline value, its variance, baseline qualification criteria, sensitivity coefficients, an expected value, and tolerance value. The baseline qualification criteria determine when a baseline value is considered valid. For instance, a baseline value may be considered valid, if statistically it describes a large enough sample. When a baseline is considered valid the calculated baseline value and the statistics measure of deviation from it are used to determine the scoring state of the monitored entity. When the baseline does not qualify as valid, the expected value and tolerance values are used, instead, to calculate the normal zone. Different threshold rules can be assigned to different attribute sets and different attribute set instances. The rules can be defined for a group of attributes sets, single sets, or a combination thereof. Rules at a more detailed level take precedence over more general one, which allows for an efficient customization of the rules to the end user's needs. The FPDE 430 may also affect the operation of the baseline analyzer 480 by providing feedback based on faults conditions detected by the FPDE 430.

The rules manager 460 allows a user to define business rules and configures the various aspects of the automated monitoring system 200. The rules manager 460 also allows users to view and modify rules that are generated by system's 200 components. Rules and configuration information are defined using a rule language. The rule language is declarative and human readable. In an embodiment of the invention, the rule manager 460 includes a rule compiler and a rule wizard which together provide a GUI for defining business rules. Rules and configuration information are saved in the DB 230-2.

The presentation and alerts engine 450 provides the interaction with a user through a set of screens and reports to be displayed on the GUI 240. The presentation and alerts engine 450 interface also generates alerts that are sent to the GUI 240 for presentation, or to an external system including, but not limited to, an email server, a personal digital assistant (PDA), a mobile phone, and the like.

The analytic processor 490 provides a higher degree of sophistication, allowing users to analyze the overall activity of the transactions. The analytic processor 490 also provides the foundation for a decision making system that not only allows users e.g. IT personnel, to operate in reactive mode and to fix catastrophes as they occur, but also to perform a proactive analysis and planning to improve the immunity and durability of their systems.

The components of the management server 220 described hereinabove can be software components, hardware components, firmware components, or a combination thereof.

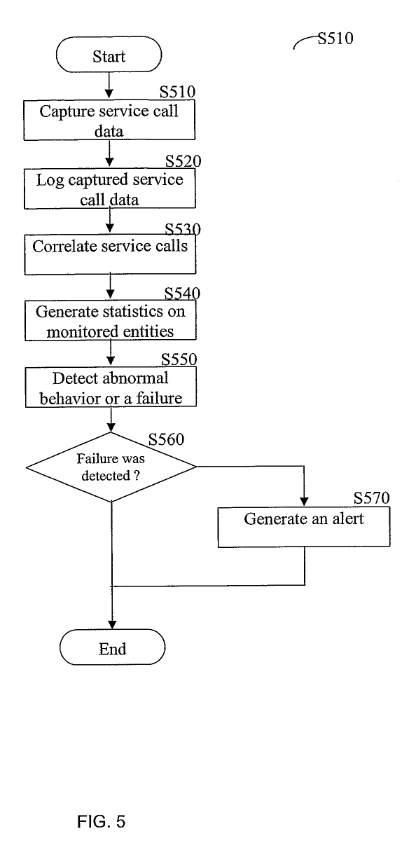

FIG. 5 is a flowchart 500 describing the operation of the automated monitoring system 200 in accordance with an exemplary and non-limiting embodiment of the invention is shown. The preferred embodiment provides alerts of flaws and faults of business transactions in service logic and identifies the root cause of these faults. At step S510, service calls are captured by the data collectors 210 as the calls are exchanged between the monitored services, e.g. the services 310. At step S520, the data are sent to an agent manager 410, which logs the incoming data in the data store DB 230-4 according to transaction rules. In addition, data that are required for the correlation are sent to the CE 420. At step S530, the CE 420 assembles incoming dispersed service calls and creates a graph that describes the instance of a transaction. Data correlation is preformed using a knowledge base that was previously accumulated and learned. The CE 420 also uses rules that are based on industry standard protocols including, but not limited to, global XML architecture (GXA), electronic Business with XML (ebXML), business process execution language (BPEL), and the others. Rules and knowledge base use for accumulation is retrieved from the DB 230-2.

At step S540, correlated data and incoming captured events are sent to the statistics processor 440, which collaborates with the baseline analyzer 480 to maintain and generate statistics on generic monitored entities. The baseline analyzer 480, using data in the DB 230-1, constantly analyzes and extracts patterns that are considered normal behavior. These patterns are the foundation threshold rules that govern the operation of the FPDE 430. At step S550, correlated data and event faults generated during the correlation and baseline analyzer are sent to the FPDE 430, which collaborates with the statistics processor 440 to detect faults and abnormalities in transaction behavior and deviations from baseline operation of generic entities in their context. At step S560, it is determined if a failure or abnormal behavior is detected, i.e. if at least one of the rules is violated and, if so, at step S570 the FPDE 430 may generate an alert that is sent to the presentation GUI 240, or to an external system. In addition, the FPDE 430 may send a command to a respective data collector 210 through collector manager 410, to increase the resolution and detail level of the collected data.

In one embodiment of the invention, the method described hereinabove may detect the root cause for a failure. To do so, the dependencies and inter-relationships between the collaborating services are constantly deduced to identify patterns that characterize faulty transactions. By means of this analysis, a set of rules is generated and used to derive more complex conditions and faulty scenarios. These rules identify faulty conditions and their cause in a much more accurate way than the threshold rules applied by the FPDE 430.

The GUI 240 operates independently from the other components of the system 200. The GUI 240 screens are based on data processed by the baseline analyzer 480 and the statistical processor 440. The GUI 240 enables the users to at least view status and alerts about transaction availability based on flows of transaction instances, navigate between dependent monitored entities associated with the faults i.e. monitored entities such as servers, services, service topologies, transaction branches, raw service calls, and the like, receive constant vitality status in a dashboard display, and receive analytical reports for specified periods.

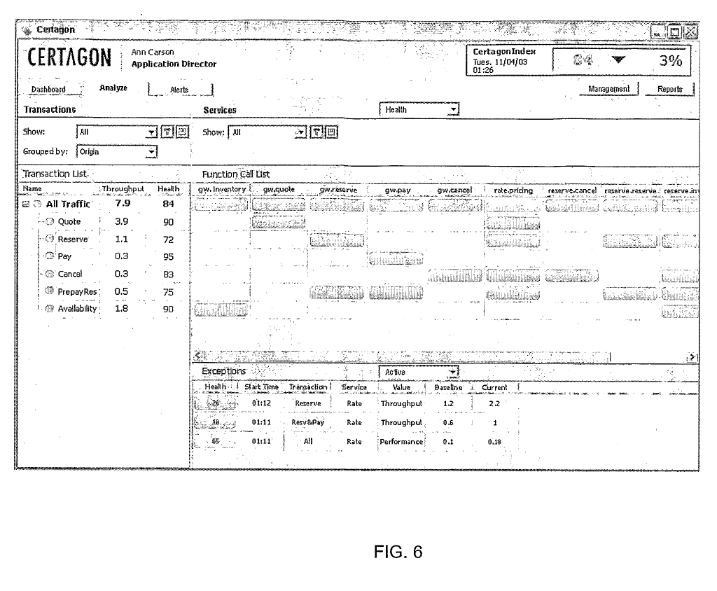

The GUI 240 includes at least one or more of the following views, optionally among other views: a matrix view and deviation graph view. FIG. 6 shows a matrix view in accordance with the invention. The matrix view of FIG. 6 provides a view at a glance of the scoring of the monitored entities. It presents a two dimensional matrix where the rows list the values of one attribute or an independent attribute, while a column lists the values of a related attribute, or a dependent attribute. Each cell 610 shows the scoring state for the crossed values of the independent and dependent attributes. The scoring state is colored in green, yellow, and red corresponding to a normal state, a degrading state, and a failure state.

In the matrix view of FIG. 6, each row corresponds to a business transaction flow, while each column corresponds to a service function call. The color of the cross cell provides the user with an immediate insight as to the relationship between the ill-behaved transactions and the service functions at which the transaction flow is passing.

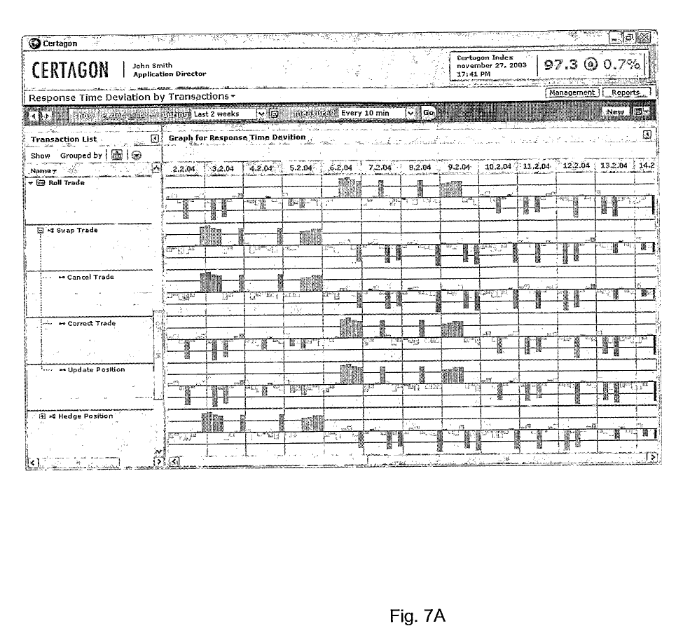

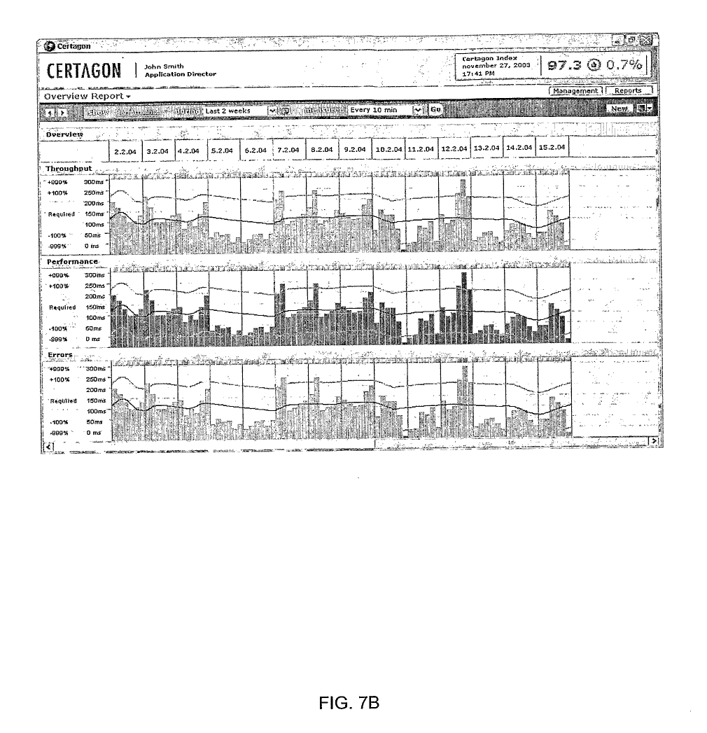

FIGS. 7a and 7b show examples of deviation graph views. Each graph in FIGS. 7a and 7b presents a different value of the same attribute and the proportional deviation of a measured value, i.e. throughput, response time, and errors from its expected deviation over a period of time. This allows the user to compare at a glance the behavior of different monitored entities, and to identify and focus on entities having the poorest performance.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for detecting performance, availability and content deviations in enterprise software applications, comprising:
a plurality of data collectors for intercepting messages exchanged between independent services in an enterprise software application; and
an analyzer for determining a baseline for said enterprise software application and for detecting deviations from said baseline.

2. The apparatus of claim 1, further comprising:
a graphical user interface (GUI) for displaying deviations from said baseline in said enterprise software application.

3. The apparatus of claim 2, said analyzer comprising:
a collector manager for controlling said plurality of data collectors;
a correlation engine (CE) for correlating streams of said messages to a transaction;
a statistical processor for collecting real-time statistics on entities within said enterprise software application;
a baseliner for determining at least said baseline, wherein said baseline represents a normal behavior of said entities within said enterprise software application;
a fault prediction and detection engine (FPDE) for performing an early detection of deviations from said baseline in said enterprise software application; and
a presentation and alerts engine for generating reports and alerts for display on said GUI.

4. The apparatus of claim 3, said analyzer further comprising:
an analytic processor for analyzing overall activity of said transactions of said enterprise software application.

5. The apparatus of claim 3, said analyzer further comprising:
a root cause analyzer (RCA) for automatically providing a detailed analysis of a root cause of each fault detected by said FPDE.

6. The apparatus of claim 3, wherein said data collectors capture messages transmitted using communication protocols comprising any of:
a simple object access protocol (SOAP);
a hypertext transfer protocol (HTTP);
an extensible markup language (XML);
a Microsoft message queuing (MSMQ); and
a Java message service (JMS).

7. The apparatus of claim 3, said FPDE performing early detection of any of:
operation faults (bugs) in said enterprise software application; and
decrement in performance of said user enterprise software application.

8. The apparatus of claim 7, wherein operation faults are detected during production of said enterprise software application.

9. The apparatus of claim 1, said data collectors receiving said messages through an application programming interface (API).

10. The apparatus of claim 1, wherein said baseline is determined based on any:
content of said messages;
context of said messages; and
real-time statistics.

11. The apparatus of claim 10, wherein said real-time statistics comprise any of:
throughput measurements; and
average response time measurements of business transactions.

12. A method for detecting performance, availability and content deviations in enterprise software applications, comprising the steps of:
intercepting messages exchanged between independent services in an enterprise software application;
correlating said messages into a transaction;
determining a baseline for said enterprise software application; and
detecting deviations from said baseline.

13. The method of claim 12, said step of detecting deviations further comprising the step of:
performing an early detection of any of operation faults (bugs) in said enterprise software application and decrement in performance of said enterprise software application.

14. The method of claim 13, further comprising the step of:
detecting said operation faults during production of said enterprise software application.

15. The method of claim 12, further comprising the step of:
displaying information about any of said operation faults and performance evaluation to a user.

16. The method of claim 15, wherein said information is displayed to said user through a series of graphical user interface (GUI) views.

17. The method of claim 12, said step of intercepting messages further comprising the step of:
receiving said messages through an application programming interface (API).

18. The method of claim 12, said step of correlating said messages further comprising the steps of:
assembling messages related to an instance of a transaction;
determining an execution flow graph of a transaction instance;
mapping said execution flow graph with similar transaction instances; and
grouping said transaction instances to create an execution path that identifies said transaction.

19. The method of claim 12, wherein said baseline is determined based on any of content of said messages, context of said messages, and real-time statistics.

20. The method of claim 19, wherein said real-time statistics comprise any of: throughput measurements, average response time measurements.

21. The method of claim 12, said method further comprising the step of:
performing a root cause analysis to detect a root cause for detected baseline deviations.

22. A computer software product readable by a machine, tangibly embodying a program of instructions executable by said machine to implement a process for detecting performance, availability, and content deviations in enterprise software applications, the method comprising the steps of:
intercepting messages exchanged between independent services of an enterprise software application;
correlating said messages into at least a business transaction;
determining a baseline for said enterprise software application; and
detecting deviations from said baseline.

23. The computer software product of claim 22, said step of detecting said deviations further comprises the step of:
performing an early detection of any of operation faults (bugs) in said enterprise software application, decrement in performance of said enterprise software application.

24. The computer software product of claim 22, further comprising the step of:
displaying information about any of operation faults and performance evaluation to a user.

25. The computer software product of claim 24, wherein said information is displayed to said user through a series of graphical user interface (GUI) views.

26. The computer software product of claim 22, said step of correlating said messages further comprising the steps of:
assembling messages related to an instance of a transaction;
determining an execution flow graph of a transaction instance;
mapping said execution flow graph with similar transaction instances; and
grouping said transaction instances to create an execution path that identifies said transaction.

27. The computer software product of claim 22, wherein said baseline is determined based on any of content of said messages, context of said messages, and real-time statistics.

28. The computer software product of claim 27, wherein said real-time statistics comprise: throughput measurements, and average response time measurements.

29. The computer software product of claim 22, said method further comprising the step of:
performing a root cause analysis to detect a root cause for detected baseline deviations.
